(19) United States
(12) Patent Application Publication
(10) Pub. No.: US 2017/0330460 A1
(43) Pub. Date: Nov. 16, 2017

(54) SYSTEM AND METHOD FOR PERMITLESS PARKING

(71) Applicant: Massey Mind, LLC, Plano, TX (US)

(72) Inventor: Nicholas J. Massey, Southlake, TX (US)

(21) Appl. No.: 15/152,523

(22) Filed: May 11, 2016

(51) Int. Cl. G08G 1/14; H04W 4/02; G07B 15/02

(52) U.S. Cl. CPC G08G 1/149; G07B 15/02; H04W 4/021

(57) ABSTRACT

Embodiments perform operation of a permitless parking system. Databases are maintained of authorized vehicles and policies associated with a parking area. As parked vehicle information is recorded, the parked vehicles are compared with the database. Based upon the comparison, vehicles are determined to be authorized or unauthorized, and handled accordingly.

### BACKGROUND

Owners and operators of a private parking area are, in many areas, permitted to tow, boot, ticket, or otherwise punish unauthorized vehicles parked in the private parking area. Some existing systems for monitoring authorized and unauthorized parking in parking areas involve authorizing a vehicle to park in the parking area, and providing the authorized vehicles with a sticker, a pass, or a tag which provide a visual indication that the authorized vehicles are authorized to park in the parking area. Typically, the authorization process is controlled by an entity who owns, manages, and/or operates the parking area.

As an example, a management company for an apartment complex typically provides a parking pass or a parking tag to a new resident, which authorizes the new resident to park a vehicle in a parking area managed/owned/operated by the management company of the apartment complex. In addition, the new resident is typically required to place the parking pass/tag in a visible location within the vehicle, such as on a dash of the vehicle, hanging from a rear view mirror of the vehicle, or placed on an inside portion of a windshield of the vehicle. However, parking passes/tags are sometimes misplaced, visually obscured by heavy window tint, difficult to see if a vehicle is parked a particular way, or there is a failure to transfer the parking pass/tag from an old vehicle (e.g., that was sold) to a new vehicle.

Additionally, in existing systems, it is cumbersome for the manager, owner, or operator of the parking area to make changes to a parking policy in a way that they can be consistently enforced. For example, in existing systems, desired changes to a parking policy are often communicated by the manager of a parking area to a manager at a towing company that enforces the parking policy. However, as those changes are disseminated by the manager at the towing company to individual tow truck drivers, the changes are often not communicated accurately or are simply forgotten by the individual tow truck drivers, leading to inconvenience, embarrassment, loss of time, and a loss of resources as authorized vehicles which are wrongfully towed must be returned to often angry owners. A failure to properly enforce the parking policy can ultimately result in a loss of business for a towing company, as the parking area owner, manager, or operator will then move the business to a different towing company.

However, even if a list of authorized vehicles is maintained by the manager/owner/operator of the parking area, it is difficult for existing systems to timely disseminate appropriate updates to towing companies and individual tow truck drivers. Additionally, while some existing systems track whether a vehicle is authorized to park in a parking area, the existing systems do not effectively track whether the authorized vehicle is complying with other regulations or laws (e.g., laws regulating parking, policies of the parking area, contractual terms agreed to by the vehicle owner, etc.). As an example, some parking areas prohibit an otherwise authorized vehicle to park in the parking area if the otherwise authorized vehicle has an oil leak. However, the parking area requires that a notice (e.g., a ten day written notice, delivered to a vehicle owner) be provided to the vehicle owner before towing the otherwise authorized vehicle. Existing systems often are unable to effectively track whether the owner of an otherwise authorized vehicle has been properly notified of the violation (e.g., the oil leak), before towing the vehicle.

### SUMMARY

One or more embodiments described herein include a system and method to enable remote authentication of a parked vehicle. At least one authorized vehicle is registered or listed in a list or parking database. The parking database is queried to determine if a parked vehicle is one of the authorized vehicles in the parking database. Upon determining that the parked vehicle is not one of the authorized vehicles in the parking database, a notification is provided indicating the parked vehicle is not authorized to park in the parking area.

This summary introduces a selection of concepts that are described in more detail below. This summary is not intended to identify essential features, nor to limit in any way the scope of the claimed subject matter.

### BRIEF DESCRIPTION OF THE DRAWINGS

FIG. 1 is a block diagram of an exemplary system for implementing the disclosed permitless parking method.

FIG. 2 is an example of a user-interface displayed on a subscriber device which is disclosed in FIG. 1.

FIG. 3 is a flowchart of an exemplary method, performed by the client device, of populating the parking database.

FIG. 4 is a flowchart of an exemplary method, performed by the subscriber device, of querying the parking database.

FIG. 5 is a flowchart of an exemplary method, performed by the subscriber device, of resolving the handling of an unauthorized vehicle.

FIG. 6 is a flowchart of an exemplary method, performed by the parking management server, of managing the permitless parking system.

FIG. 7 is a flowchart of an exemplary method, performed by the subscriber device, of resolving the handling of a vehicle parked in violation of a local policy.

FIG. 8 is an example workflow, as performed by the permitless parking system.

FIG. 9 is a block diagram of an exemplary host computing device, such as the client and subscriber devices disclosed in FIG. 1.

Corresponding reference characters indicate corresponding parts throughout the drawings.

### DETAILED DESCRIPTION

Embodiments described herein describe systems and methods for permitless parking management. A parking database is populated with information that identifies vehicles authorized to park in a parking area. The parking database is queried to determine if parked vehicles are authorized. Thereafter, a user is presented with results of the query, and acts accordingly.

The disclosed embodiments enable parking to be managed without a need to issue permits, tags, stickers or other visual indicators that a vehicle is authorized to park in a parking area. This allows for more effective and more efficient management of parking areas in that vehicles that are not authorized to park in a parking area are more quickly identified and managed. Likewise, changes to vehicles authorized to park in a parking area, or to parking policies, are quickly disseminated upon request by a manager/operator/owner of a parking area (e.g., a client of a towing company). The system minimizes the opportunity for an erroneous identification of a vehicle that is authorized to park in a parking area as a vehicle that is unauthorized to park in the parking area, reducing costs associated with litigation, damage claims, and loss of business that would result from towing a vehicle that is authorized to park in the parking area.

Significant time and money is also saved for the manager/operator/owner of a parking area. Permits, tags, stickers or other visual indicators fade with time and exposure to sunlight, are counterfeited, are sold by an authorized user to an unauthorized user, are not always returned when authorization to park is revoked, etc. The disclosed embodiments eliminate these problems by eliminating a need for the visual indicator conventionally required. Likewise, the disclosed embodiments remove a need to reissue the permits, tags, stickers, passes, etc. upon expiration. Further, the disclosed embodiments eliminate a need for visitor permits to be handwritten by the manager/owner/operator of the parking area. Furthermore, there is no need to change the styling of the visual indicator (shape, color, numbering, etc.) in an attempt to avoid the problems listed above.

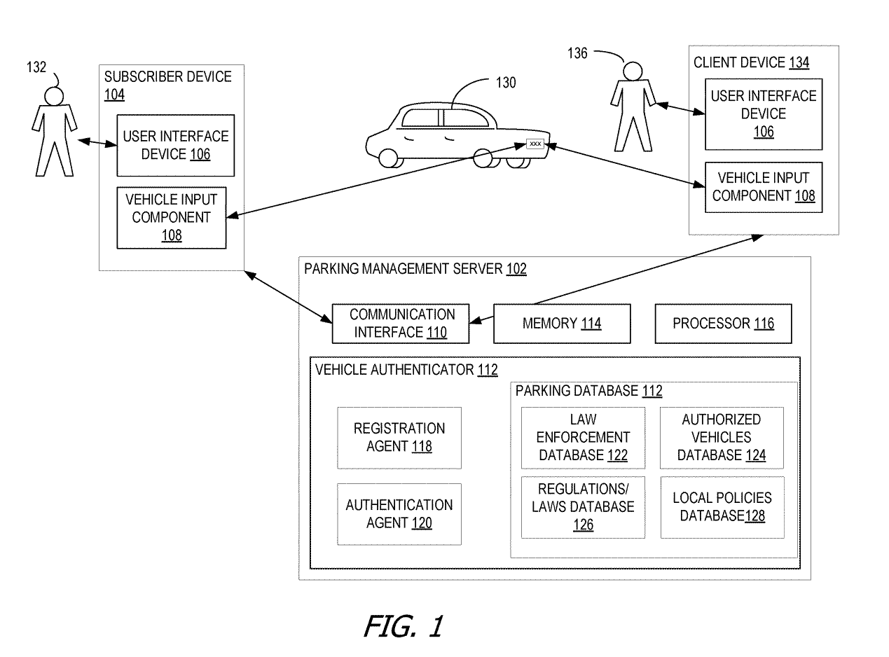

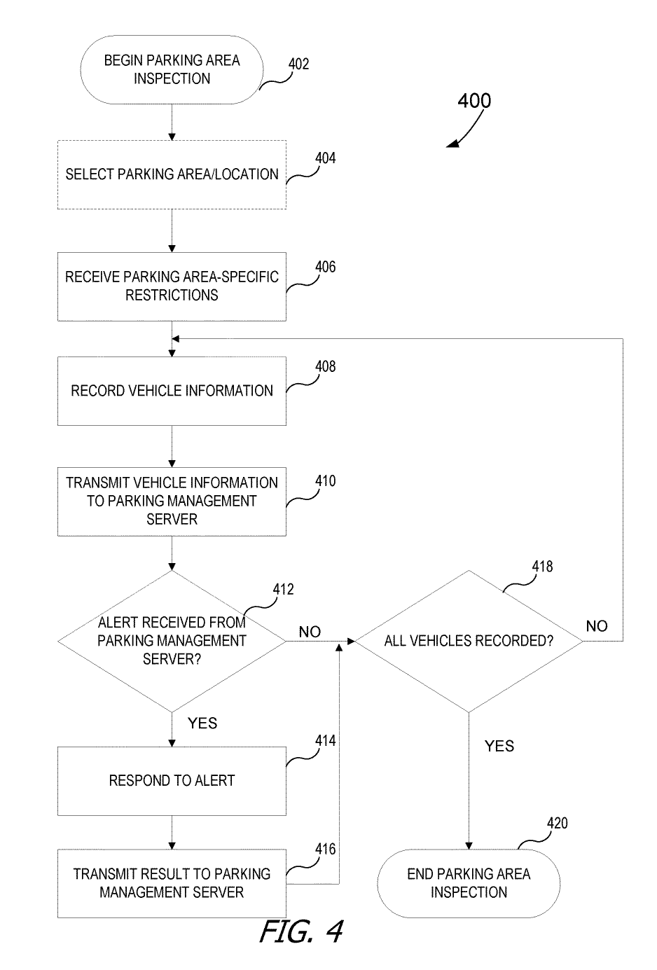

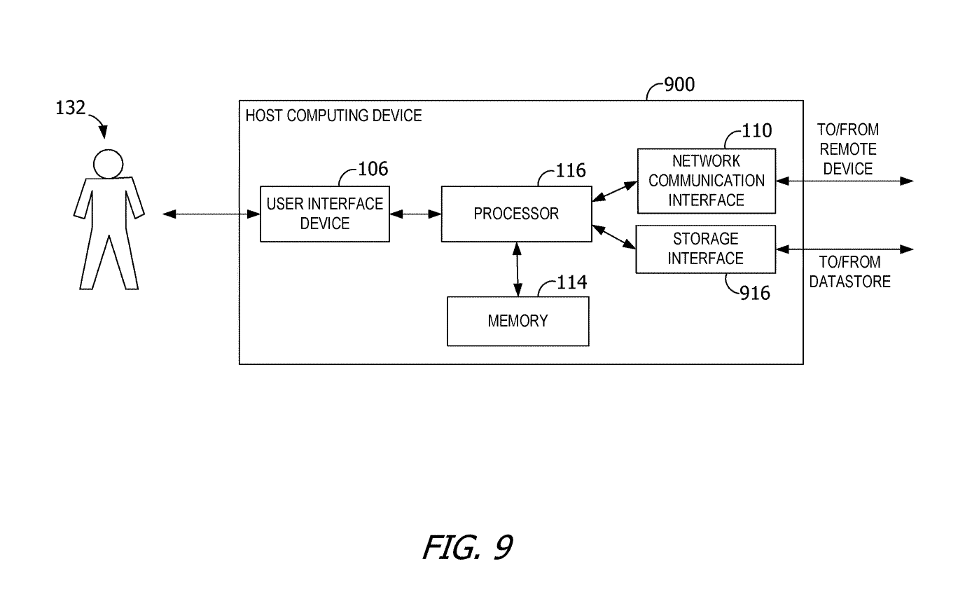

FIG. 1 is a block diagram of an exemplary permitless parking system 100 for implementing the disclosed methods shown in FIGS. 4-7. The permitless parking system 100 includes a subscriber device 104, a client device 134, and a parking management server 102. The subscriber device 104, the client device 134, and the parking management server 102 are, in some examples, host computing devices as illustrated in FIG. 9, and disclosed in the accompanying text.

In the illustrated example shown in FIG. 1, the subscriber device 104 is utilized by a user 132, such as a tow truck driver, parking area inspector, security guard, law enforcement, etc. The client device 134 is, in some examples, operated by a client 136 such as a parking area manager, an apartment complex manager, a vehicle owner or operator, etc. The parking management server 102 is communicatively connected to both the subscriber device 104 and the client device 134, via a communication interface 110. In some examples, the parking management server 102 is cloud-based.

Both the client device 134 and the subscriber device 104 may include user interface devices 106 (e.g., a first user interface device and a second user interface device) and vehicle input components 108 (e.g., a first vehicle input component and a second vehicle input component). Further, the client device 134 and the subscriber device 104 are host computing devices (illustrated in more detail in FIG. 10) in some examples. Alternatively, the client device 134 and the subscriber device 104 do not execute any operations locally, and merely act as terminals while all operations are executed on or by the parking management server 102. The client device 134 and the subscriber device 104 are, for example, existing mobile user devices, such as cellular telephones, tablets, laptop computers, smartphones, and other mobile computing devices. When the disclosed methods are performed on existing mobile user devices, the parking system 100 includes, in some examples, a downloadable application which interfaces with any other necessary equipment using interface device 106. Examples of the interface device 106 include a keyboard, a pointing device, a mouse, a stylus, a touch sensitive panel (e.g., a touch pad or a touch screen), a position detector, display screen, and/or an audio input device.

In some examples, the client device 134 is operated by the client 136 associated with a parking area, such as a parking area owner or manager. Alternatively, the client device 134 is associated with the same user (e.g., the user 132) as the subscriber device 104. In other examples, the client device 134 is publicly accessible. In examples where the client device 134 is publicly accessible, the client device 134 accepts payment to add a vehicle associated with the user 132 to a parking database 112 as an authorized vehicle during an authorized defined period of time. As an example, the client 136, which may be a visitor to a parking area, accesses the client device 134 and pays for two hours of parking. In this example, the vehicle associated with the client 136 is authorized to park in the parking area for a two hour period, after which the vehicle is de-authorized or removed as an authorized vehicle from the parking database 112. In some examples, the subscriber device 104 is notified when a vehicle in a parking area is nearing the expiration of its authorized period.

The subscriber device 104, similar to the client device 134, includes the user interface device 106 and the vehicle input component 108 as disclosed above. The vehicle input component 108 includes, in some examples, a camera, a scanner, or other equipment to read an image with information such as license plate numbers, vehicle identification numbers (VINs), barcodes, etc. In some embodiments the camera or scanner is associated with character recognition software, which translates the image into text for evaluation by other modules or agents, such as authentication agent 120, discussed below.

The parking management server 102 further comprises various modules, components, and/or databases. It includes a communication interface 110, which communicates with both the subscriber device 104 and the client device 134. The parking management server further comprises a memory 114, a processor 116, and a vehicle authenticator 112. The vehicle authenticator 112 is programmed to execute instructions to receive and process information from both the client device 134 and the subscriber device 104. Specifically, the registration agent 118, operating as part of the vehicle authenticator 112, receives a list of one or more authorized vehicles from the client device 134. The registration agent 134, in some embodiments, also receives the list of authorized vehicles from the subscriber device 104, and other information from either the client device 134, the subscriber device 104, or other external sources. The other information includes items such as parking policies, local laws and regulations, law enforcement alerts, etc.

The received information is used by the registration agent 118 to populate various databases of the parking database 112. Specifically, alerts from law enforcement, such as be on the lookout (BOLO) alerts, Amber and Silver alerts (e.g., alerts regarding missing children and missing elderly), etc. are stored in law enforcement database 122, a list of authorized vehicles are recorded in an authorized vehicle database 124, and applicable regulations and laws are stored in the regulations/laws database 126. Local policies, such as parking policies or contracts associated with the parking area, are stored in a local policies database 128. The information stored in the parking database 112 is, in some examples, retrieved by the parking management server 102 from one or more external databases (not illustrated). In other examples, the parking management server 102 receives the information, through a push-service, listserv, mailer, etc. Other information sources include administrative agencies, collections agencies, etc. Parking and traffic violations, repossession notices, warrants, and any additional violations are received/retrieved and stored, in some examples, in the parking database 112.

The authentication agent 120, also part of the vehicle authenticator 112, operates to determine whether parked vehicles, detected by the subscriber device 104, are authorized to park in the parking area. In some examples the authentication agent 120 executes instructions to receive a list of parked vehicles from the subscriber device 104 via the communication interface 110. A parked vehicle is compared to a list of authorized vehicles in the parking database 112 and thereafter, the authentication agent 120 is programmed to notify the subscriber device 104 if the parked vehicle is not listed in the authorized vehicle database 124. In some examples, no vehicles are authorized and the authorized vehicle database 124 is empty.

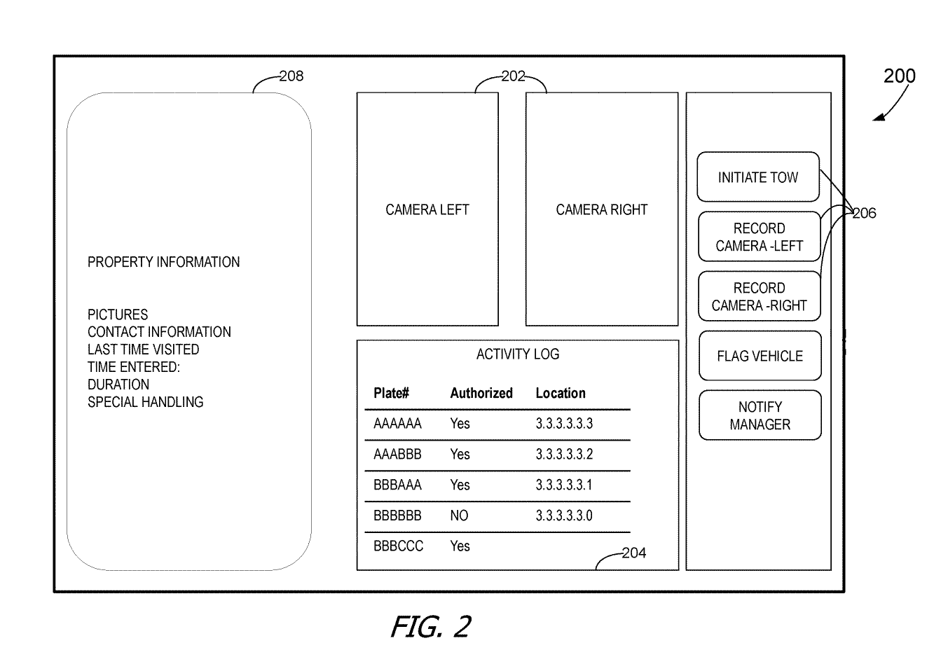

FIG. 2 is an example of a user-interface 200 which is displayed upon the user interface device 106 of the subscriber device 104. While FIG. 2 is one possible implementation of a user interface, other interfaces are contemplated and the embodiments described herein or not limited to the user-interface 200 shown in FIG. 2. In the example of FIG. 2, several elements provide the user 132 with information and opportunities to interact with the permitless parking system 100. As an example, camera input 202 is displayed for the user 132. In the illustrated example, camera input 202 includes a left and right camera (as oriented from a patrolling vehicle). However, alternative configurations are contemplated, such as a camera which rotates, a 360 degree camera, or other technology which records vehicle information without a camera. An activity log 204 displays, in some embodiments, recorded vehicles, authorization status, and a location of vehicles. The user-interface 200 includes, in some examples, interface options 206 such as buttons, hyperlinks, clickable menus, etc., for options such as initiating a tow, recording camera input, flagging vehicles, notifying a parking area manager, etc. Additionally, parking area information 208 is displayed. In alternative embodiments, other information, interfaces, methods of interaction, etc. are contemplated. The features described here are exemplary and not limiting.

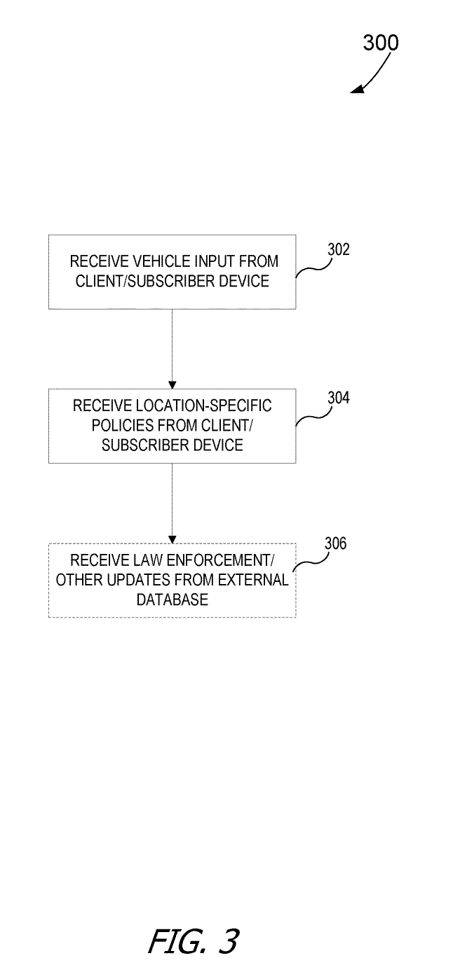

FIG. 3 is a flowchart of an exemplary method, performed by the client device 134, of populating the parking database on the parking management server 102. In the example of FIG. 3, the parking management server 102 receives input, such as images, text, etc., from the client device 134, and from other sources such as additional databases, or the subscriber device 104. The input received by the parking management server 102 is manually inputted in some examples into either the client device 134 or the subscriber device 104. Alternatively, the input is automatically received as a file, database, communication, etc.

At 302, the parking management server 102 receives vehicle input from the vehicle input component 108 or the user interface device 106 of the client device 134. The vehicle input is transmitted to the communication interface 110 of the parking management server 102, where the registration agent 118 of the vehicle authenticator 112 stores a list of the authorized vehicles in the parking database 112, in the authorized vehicles database 124. The registration agent 118 registers, stores, or otherwise catalogues the information received from the client device 124 regarding identifying information of authorized vehicles. In some examples, the registration agent 118 is programmed to conform disparate types of input information associated with authorized vehicles into a uniform database, list, array, or other data storage device. In some examples, the registration agent 118 calculates a hash of identifying information associated with an authorized vehicle, and a table of the hashes is created to allow faster searching of the authorized vehicles.

In some examples, the vehicle input is received as scans of a license plate, license plate characters, vehicle identification number, other vehicle-specific mark, tag, or identifier. Alternatively, the vehicle input is received through manual input by the user 132 or the client 136. In other embodiments, an existing list of vehicles in a database, a spreadsheet, a text file, an array, or other document is uploaded to the parking management server 102 at 302. The vehicle input contains a list of vehicles which are authorized to park in the parking area. In some examples, the subscriber device 104 populates the parking database 112. Alternatively, the parking management server 110 interfaces directly with an external client system (not illustrated). In this example, the input information is retrieved by an application programming interface (API).

At 304 the parking management server 102 receives additional information from the client device 134, or in some examples from the subscriber device 104. The additional information includes, as an example, the location of the parking area, parking restrictions for the parking area, contact information for the owner, operator, or manager of the parking area, a list of owners of authorized vehicles and their contact information, a list of policies for the parking area, information regarding the law enforcement agency which patrols the area, etc. This additional parking area specific information is stored in the local policies database 128 of the parking database 112. In some examples, the vehicle input from the client device 134 includes additional instructions, such as instructions not to patrol the parking area on certain days, at certain hours, etc.

In some examples, additional location-specific information is inputted, uploaded, downloaded, retrieved, communicated, etc. to or by the parking management server 102. As an example, the user 132, via the subscriber device 104, or the client 136 via the client device 134, inputs information about assigned parking (e.g., a specific parking space associated with a specific authorized vehicle), fire lanes, or geo-fenced locations. In the example of geo-fencing, specific global positioning system (GPS) coordinates are outlined, specified, detailed, marked, etc. by the user 132 or client 136. In some example, the geo-fenced coordinates are configured to outline spaces, a perimeter, or sub-areas of the parking area which are prohibited, reserved, associated with a specific authorized vehicle, or otherwise have parking restrictions.

Further, location-specific regulations or laws are also received at 304. As an example, parking laws specific to a city, a county, or a state where the parking area is located are uploaded from the client device 134 or the subscriber device 104, or downloaded from an additional database. In some examples, the parking management server 102 queries the various additional databases for updates. As an example, the parking management server 102 queries an external law enforcement database for updates to the law enforcement database 122 on a once-daily schedule, or more or less frequently based upon a policy federated by an administrator.

Optionally, at 306, the parking management server 102 queries additional databases for law enforcement updates, or other updates. The parking management server 102 is in communication with the one or more additional databases (not illustrated), constantly, or intermittently. The types of additional databases include a police database, a local parking regulations database, a state parking regulations database, a parking area regulations database, etc. In some examples, the one or more additional databases provide bulletins or updates which the parking management server 102 stores in the parking database 112. As an example, law enforcement alerts are either retrieved from an additional database, received as a broadcast from the additional database, received through manual input, etc. and stored in the law enforcement database 122.

FIG. 4 is a flowchart of an exemplary method 400, performed by the subscriber device, of querying the parking database 112. The operations performed in FIG. 4 are performed, in some examples, synchronously and asynchronously in other examples. The illustrated example is an example of remote, synchronous querying of the parking database 112, where vehicle information is compared to information in the parking database 112 on the parking management server 102 as the vehicle information is recorded. In alternative embodiments (not illustrated), content of the parking database 112 is downloaded to the subscriber device 104, and the comparison occurs synchronously, but on the subscriber device 104. In another alternative embodiment (not illustrated), information on vehicles in the entire parking area is recorded, the vehicle information is uploaded to the parking management server 102 for asynchronous, remote comparison with the parking database 112, and the results are transmitted by the parking management server 102 to the subscriber device 104.

At 402 an inspection of the parking area begins. In some examples, the inspection is initiated on the subscriber device 104, by the user 132. Alternatively, the inspection initiates when a global positioning system (GPS) device (not shown) associated with the subscriber device 104 determines that its current location is within the parking area. In another embodiment, the subscriber device 104 uses the vehicle input component 108 to determine that the subscriber device 104 is located within the parking area (e.g., the camera or scanning system detects information such as a sign or barcode associated with the parking area). In some examples, the subscriber device 104 recognizes, is notified, or otherwise determines that it has crossed onto the parking area. As an example, the parking area is geo-fenced, or otherwise delineated. In the example of the geo-fenced parking area, the subscriber device 104 receives an alert from the parking area (e.g. a transmitter associated with the parking area). In other examples, the subscriber device 104 scans the sign, marquis, or other indicia describing the location of the parking area, in order to determine the location of the parking area.

Optionally, if the parking area is not automatically determined using the techniques described above, at 404 the user 104 selects the parking area or location from a list of locations supplied by the parking management server 102. The list is, in some examples, displayed on the user interface device 106. In those examples, the user 132 selects the appropriate parking area from the list, using the user interface device 106, and the parking management server 102 is notified of the appropriate parking area.

At 406, based upon the parking area determined in operations 402 or 404, the subscriber device 104 receives, from the parking management server 102, or retrieves, from the parking management server 102, the parking area-specific and location specific policies, regulations, laws, and/or restrictions. In some examples, these policies and restrictions are retrieved from the parking database 112, and specifically, from the law enforcement database 122, the regulations/laws database 126, and/or the local policies database 128. The retrieval of the parking area specific information, in some examples, prompts a pop-up, informational window, or other notice to the user 132 of the subscriber device 104. An acknowledgement from the user 132 of the subscriber device 104 is required, in some embodiments, before proceeding to subsequent operations. Examples of informational pop-ups include information such as a prohibition against head-out parking at the parking area, a reminder not to tow vehicles during specified hours, or any other parking area specific information which the user 132 of the subscriber device 104 should be aware of before towing a vehicle from the parking area.

Upon reviewing any parking area specific restrictions, laws, regulations, etc. at 406, the subscriber device 104 begins to record vehicle information at 408. In some examples, the vehicle input component 108 or the user interface device 106 of the subscriber device 104 records the vehicle information. As an example, the cameras 202 (one example of the vehicle input component 108) record license plate numbers or other vehicle-specific information. Alternatively, vehicle information is manually entered by the user 132 on the user interface device 106. In another embodiment, a scanner is used to record the vehicle information.

At 410, in the illustrated synchronous example of querying the parking management server 102, the recorded vehicle information is transmitted to the parking management server 102 via the communication interface 110. In the asynchronous examples above, the parking database 112 associated with the parking area is downloaded, retrieved, or otherwise made local to the subscriber device 104. In some examples, all of the vehicle information for the entire parking area is recorded before transmissions of vehicle information are made. In other examples, as vehicle information is recorded, it is transmitted to the parking management server 102, or a query to the parking management server 102 is made by the subscriber device 104.

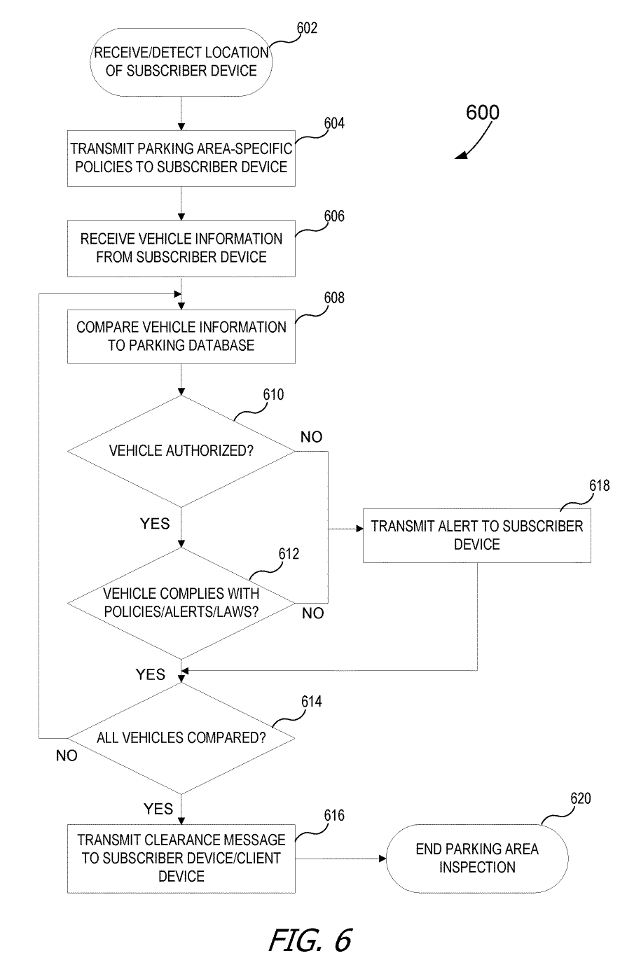

Upon receiving the vehicle information, the authentication agent 120 of the parking management server 102 compares the vehicle information to the list of authorized vehicles maintained by the authorized vehicle database 124 in the parking database 112. This operation, and the other operations performed at the parking management server 102 in the example of asynchronous or synchronous remote querying are illustrated in FIG. 6, and described in the associated text. The results of the operations performed at the parking management server 102 by the authentication agent 120 are received as alerts from the parking management server 102 at 412. The parking management server 102, in some examples, presents information that an identified or parked vehicle is unauthorized, that a parked vehicle is the subject of a law enforcement notice, that the parked vehicle previously violated a policy (prompting the user 132 to check compliance with the policy during the present inspection), etc.

In some examples, where the information is downloaded from the parking management server 102 to the subscriber device 104, the alerts are generated by comparing the identified or parked vehicles to the information downloaded from the parking database 112 to the subscriber device 104. As an example, in the embodiment where the parking database 112 is downloaded to the subscriber device 104, the processor on the subscriber device 104 (illustrated in FIG. 9 and described in the accompanying text) is programmed to compare the recorded or transmitted vehicle information associated with the authorized vehicles in the authorized vehicle database 124.

In examples where the parking database 112 is downloaded to the subscriber device 104, it is not required that the entire database be copied or cloned to the subscriber device 104. In some examples, to save space on a memory of the subscriber device 104 and to reduce transmission length and bandwidth usage between the subscriber device 104 and the parking management server 102, a hash is created, by the parking management server 102, of the identifying information associated with the authorized vehicles on the authorized vehicle database 124 associated with the parking area. In this example, instead of transmitting all of the contents of the authorized vehicle database 124, the hash of those contents is transmitted or downloaded by the subscriber device 104, and the recorded vehicle information is similarly hashed by the subscriber device 104, and the hashes are compared. In the examples where the content of the parking database 112 is downloaded to the subscriber device 104, any vehicles identified by the subscriber device 104 as unauthorized vehicles upon comparison to the authorized vehicles database 124 are uploaded, transmitted, or otherwise reported back to the parking management server 102 as unauthorized. Alternative techniques of saving space, bandwidth, and processing resources are contemplated.

If no alerts are received from the parking management server 102, or otherwise displayed on the subscriber device 104, then the user 132 is asked to confirm to the subscriber device 104 that all vehicles are recorded by the subscriber device 104 at 418. If all vehicles are not recorded at 418, then the system continues to record vehicle information at 408. However, if an alert is displayed (either from the parking management server 102 or generated by the subscriber device 104) at 412, then the user 132 is prompted to respond to the alert. At 414 the user 132 responds to the alert. In some examples, the alert is ignored. Alternatively, the alert is acknowledged, or some other response is indicated by the user 132. As an example, the user 132 indicates that the vehicle which is the subject of the alert is towed, booted, ticketed, marked for follow-up, flagged, or otherwise indicated for further action.

After responding to the alert at 414, the subscriber device 104 transmits the response or result to the parking management server 102 at 416. As an example, the subscriber device 104 notifies the parking management's server 102 that the parked vehicle, which was identified as unauthorized, is towed, booted, ticketed, etc. Upon transmitting the result to the parking management server 102, the user 132 confirms that all vehicles are recorded at 418. If all vehicles are not recorded, the system returns to recording vehicle information at 408. Otherwise, the parking area inspection concludes at 420.

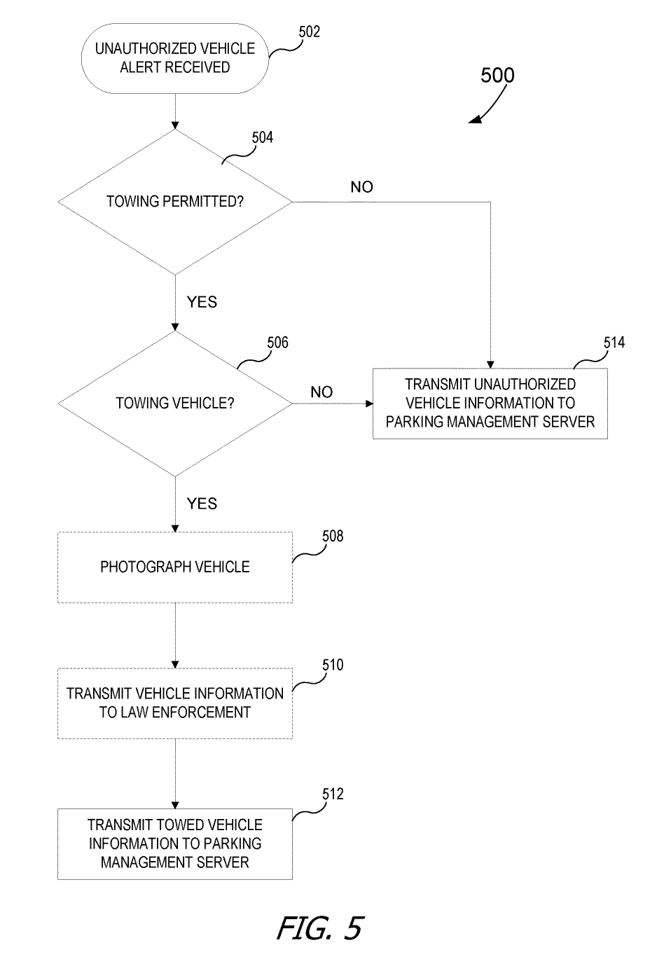

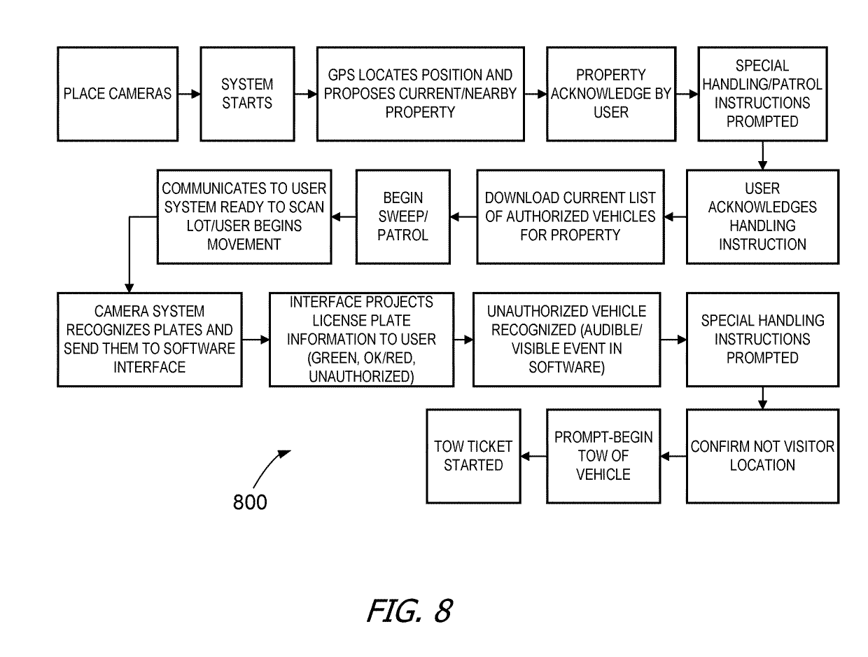

FIG. 5 is a flowchart of an exemplary method 500, performed by the subscriber device 104, of resolving the handling of an unauthorized vehicle. A more detailed example of a workflow performed by the subscriber device 104 is illustrated in FIG. 8. In the example of FIG. 5, an unauthorized vehicle alert is received at 502. In some examples, the alert is received from the parking management server 102 and displayed by the subscriber device 104 to the user 132. Alternatively, the alert is triggered by instructions executed by the processor on the subscriber device 104. In that example, the parking database 112 is locally downloaded to the subscriber device 104, and the subscriber device 104 compares the recorded vehicles with the parking database 112, and discovers an unauthorized vehicle. The discovery of the unauthorized vehicle triggers the alarm displayed to the user 132 on the subscriber device 104 at 502.

The subscriber device 104 or the parking management server 102, depending on whether the processing is occurring remotely or locally, evaluate whether towing is permitted of the unauthorized vehicle from the parking area at that time. In some examples, the user 132 is prompted to answer questions regarding the status of the identified unauthorized vehicle, to provide information necessary to determine if towing is permitted (e.g., if a second violation of a parking policy or regulation is required before towing, the user 132 is prompted to acknowledge the requirement and affirm it is satisfied). If towing is not permitted, then information for the unauthorized vehicle information is transmitted to the parking management server 102 at 514. In some examples, this triggers an alert to the client 136 of the client device 134. As an example, the manager of the parking area is notified of the parked vehicle identified as unauthorized, but which was not towed because towing was not permitted.

If towing is permitted at 504, the subscriber device 104 evaluates if the vehicle is towed at 506. In some examples, the camera affixed to the towing vehicle records the towed vehicle to evaluate whether the towing is occurring. Alternatively, the user 132 is prompted to confirm or reject that the vehicle is being towed. If the vehicle is not being towed, but is permitted to be towed, then the information regarding the unauthorized, untowed vehicle is transmitted to the parking management server 102 at 514.

If the unauthorized vehicle is towed at 506, various operations are performed by either the subscriber device 104 or the parking management server 102. In some examples, if the unauthorized vehicle was not photographed, then it is optionally photographed at 508. For instance, if license plate character scanning technology is used to identify vehicles, actual photographs of unauthorized vehicles are later taken. In some examples, these photographs are stored on the parking management server 102 for a specified amount of time (e.g., until the time period for insurance claims or the statute of limitations for lawsuits has elapsed). In some examples, photographs of unauthorized vehicles are also maintained to compare with older photographs, to determine if violations of parking area policies are corrected. As an example, the parked vehicle with a flat tire is in violation of the policy. The photograph of that vehicle is compared with earlier photographs of the same vehicle to determine the duration of the violation.

At 510, towed, unauthorized vehicle information is optionally transmitted to law enforcement. This operation, while illustrated as subsequent to the towing of the unauthorized vehicle, occurs at any point subsequent to identifying the parked vehicle as a vehicle of interest. As an example, identified or recorded parked vehicles are compared to the law enforcement database 122 on the parking database 112 (either locally, when the database is downloaded to the subscriber device 104 or remotely at the parking management server 102). In some examples, the comparison will result in determining that some of the identified vehicles are vehicles of interest, or “be on the lookout” (BOLO) vehicles. In some examples, the system prompts the user 132 to notify local law enforcement. In other examples, the system automatically notifies law enforcement that the parked vehicle, identified as subject to a BOLO, Amber alert, Silver alert, etc., is identified, and its location. In some examples, based upon instructions stored in the law enforcement database 122, regulations or laws stored in the regulations/laws database 126, or policies stored in the local policies database 128, parked vehicles subject to the alerts are vehicles are flagged as do not tow or boot, notwithstanding whether they are unauthorized.

At 512 information about the towed vehicle is transmitted to the parking management server 102. In some examples, information regarding towed vehicles is aggregated over the course of a day or other period of time by the subscriber device 104, and is sent at the same time as a packet to the parking management server 102. Alternatively, every time a parked vehicle is identified as unauthorized, towed, booted, ticketed, etc., the vehicle information is transmitted to the parking management server 102 by the subscriber device 102. In some examples, the parking management server 102 or the subscriber device 104 also generates and transmits to the client device 134 a digest of recorded vehicle information, towed vehicle information, etc.

FIG. 6 is a flowchart of an exemplary method 600, performed by the parking management server, of managing the permitless parking system 100. The example of FIG. 6 illustrates the operations performed when the parking management server 102 and the subscriber device 104 are in synchronous communication, and the operations to query the parking database 112 are performed at the parking management server 102 (in contrast to other embodiments disclosed herein, where the operations are performed locally by the processor operating on the subscriber device 104). In other examples, the operations are performed asynchronously, or locally on the subscriber device 104. In the asynchronous example, the user 132 records vehicle information in batches, or in total, transmits the recorded vehicle information, and receives results of the comparison between the recorded vehicle information transmitted to the parking management server 102 and the parking database 112.

In the illustrated example, the parking management server 102 receives or detects the location of the subscriber device 104. In some examples, the user 132 selects the parking area which the user 132 is patrolling, and the subscriber device 104 notifies the parking management server 102 of the selection. Alternatively, the subscriber device 104 includes a global positioning system (GPS) which determines the location of the subscriber device 104 by comparing the GPS coordinates to the location of parking areas stored in the parking database 112. In other embodiments, the subscriber device 104 relies upon other indicia (geo-fencing, signage, barcodes, authorized vehicle information, etc.) to determine and transmit the location of the subscriber device 104 to the parking management server 102. As an example, the subscriber device 104 scans a sign associated with the parking area and uses character recognition software to determine the location, the subscriber device 104 scans a barcode associated with the parking area and posted at the entrance to the parking area, or the subscriber device 104 receives a signal from a transmitter at the parking area which identifies the parking area.

Upon determining or receiving the location of the subscriber device 104, the parking management server 102 transmits applicable parking area specific information to the subscriber device 104. In some examples, this information is retrieved from databases on the parking database 112. As an example, the parking management server 102 transmits law enforcement alerts from the law enforcement database 122, local policies from the local policies database 128, and regulations and laws from the regulations/laws database 126. The various databases are populated, in some examples, by either user 132, clients 136, or with information from additional databases. In the example of information from additional databases, the parking management server 102, in some examples, retrieves the information from the additional external databases; in other examples the parking management server receives updates, bulletins, or notices from the additional external databases. The parking management server 102 also, in some examples, retrieves information from websites, uploaded files and documents, etc.

At 606 the parking management server 102 begins receiving parked vehicle information from the subscriber device 104. In some examples, the information is manually inputted by the user 132 to the subscriber device 104. In other examples, the subscriber device 104 includes cameras, scanners, or other visual input systems which interface with software allowing vehicles to be identified by their license plates, vehicle identification numbers (VINs), or other identifying information. This identifying information is transmitted to the parking management server 102. In some examples, a hash of the identifying information is calculated, and transmitted to the parking management server 102.

Upon receiving the recorded vehicle information from the subscriber device 104, the parking management server 102 compares the recorded vehicle information to the information stored by the authorized vehicle database 124. In some examples, the authentication agent 120, operating as part of the vehicle authenticator 112, receives information on the parked vehicles which have been identified, and performs the comparison. In those examples, the authentication agent 120 is programmed to execute instructions to compare received vehicle information to stored vehicle information identifying vehicles authorized to park in the parking area. The authorized vehicles are identified by VIN, license plate, make, model, color, or other identifying information, or a hash of any of those identification methods. If the identifying information of the parked vehicle is not located in the parking database 112, then the authentication agent 120 identifies the parked vehicle as unauthorized.

Upon making the comparison between the parked vehicle information and the authorized vehicles, the authentication agent 120 identifies any vehicle which is unauthorized versus authorized at 610. In the illustrated example of FIG. 6, the comparison is synchronous (e.g., it is performed vehicle by vehicle, as the vehicles are identified or recorded by the subscriber device 104 and transmitted to the parking management server 102); however, the comparison is also performed asynchronously, with batches of recorded vehicle information transmitted to the parking management server.

At 612, if the parked vehicle is determined to be authorized, it is still compared to the other databases in the parking database 112 to evaluate whether the parked vehicle complies with other policies and regulations. In that comparison, the authentication agent 120 evaluates, in some examples, whether the parked vehicle is subject to any law enforcement alerts by comparing it to the law enforcement database 122, whether the recorded vehicle is in violation of any regulations or laws by comparing it to the regulations/laws database 126, or whether the recorded vehicle violates any local policies by comparing it to the local policies database 128.

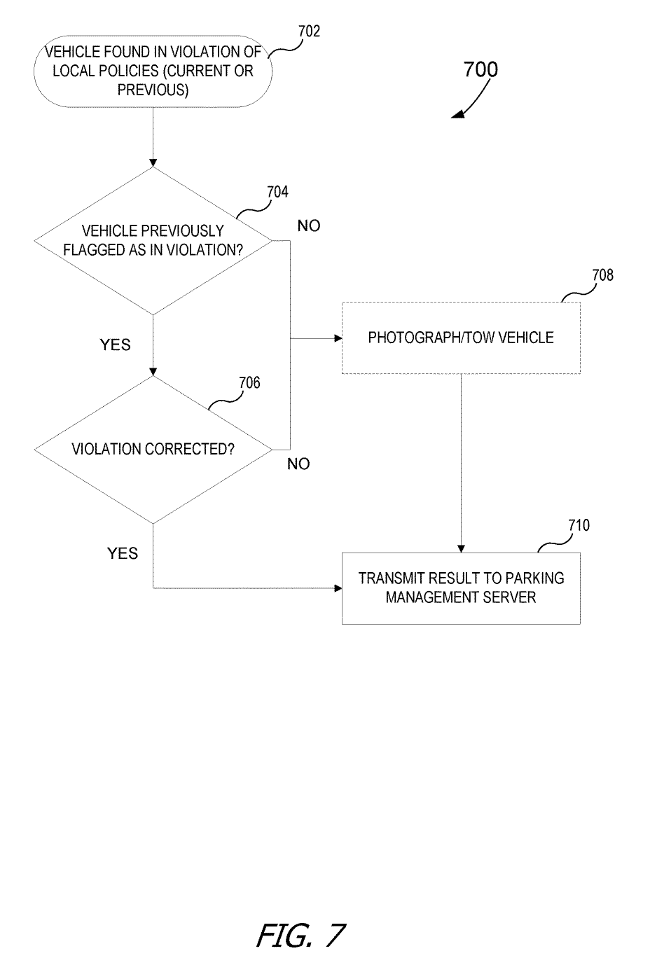

If at 610 the recorded vehicle is determined to be unauthorized or if an authorized vehicle violates another policy, rule, law, etc., then an alert is transmitted by the parking management server 102 to the subscriber device 104 at 618. The alert, in some examples, indicates to the user 132 that the vehicle is unauthorized. In other examples, the alert indicates that the vehicle is authorized but parked in violation of some other rule, policy, law, regulation, etc. One possible response to an alert is illustrated in FIG. 7 and the accompanying text.

At 614, if all of the vehicles are recorded and compared to the databases in the parking database 112, then an all clear message is transmitted to the subscriber device 104. The all clear message is, in asynchronous embodiments, an indicator that all recorded vehicles are processed by the parking management server 102. In other embodiments, such as synchronous embodiments, the all clear message is a query from the parking management server 102, confirming that the subscriber device 104 has recorded all vehicles in the parking area. In some examples, the message is also transmitted to the client 136 by way of the client device 134, on its own or as part of the digest to the client 136 indicating the results of the inspection of the parking area. If all vehicles are not recorded and compared at 614, then the system continues to perform comparisons at 608 until all vehicles are compared. Upon completion of all of the comparisons, the parking facility inspection ends at 620.

As discussed previously, the operations performed by the parking management server 102, although illustrated in FIG. 6 as synchronous and performed by the parking management server 102, can be performed both asynchronously or synchronously, and either by the parking management server 102 or the subscriber device 104. In the embodiment where the operations are performed by the subscriber device 104, the content of the parking database 112 is downloaded to the subscriber device 104 or retrieved by the subscriber device, and the operations are performed by the processor on the subscriber device 104 instead of by the agents operating on the vehicle authenticator 112.

FIG. 7 is a flowchart of an exemplary method 700, performed by the subscriber device 104, of resolving the handling of a vehicle parked in violation of a local policy. The operations performed in FIG. 7 are not exhaustive, and based upon the alerts received from the parking management server 102 or generated by the subscriber device 104, other operations are anticipated.

At 702 a vehicle is flagged as “in violation” of local policies (or in other examples, regulations, laws, etc.). A vehicle is identified as “in violation” if it is currently in violation of the local policy associated with the parking area, or alternatively, the vehicle is flagged by the parking management server 102 or the subscriber device 104 as “previously in violation” of the local policy.

At 704, if the parked vehicle was flagged as “previously in violation” of the local policy, the user 132 or the subscriber device 104 evaluates whether the violation is currently corrected at 706. Upon determining that the violation is corrected at 706, the result is transmitted to the parking management server 102. In some examples, upon receiving the message that the violation is corrected, the violation is cleared from the record of the parked vehicle, so that it will not trigger an alert as “in violation” if it is recorded again by the subscriber device 104.

If the parked vehicle is “in violation” at 702, but not identified as “previously in violation” at 704, then optionally at 708 the vehicle is photographed and/or towed, ticketed, booted, or notice provided to the vehicle owner, the client 136, law enforcement, or other party. Likewise, if the vehicle is found “in violation” at 702, was previously found “in violation” at 704, and the violation remains uncorrected at 706, then the vehicle is optionally photographed and/or towed, ticketed, booted, or notice provided to the vehicle owner, the client 136, law enforcement, or other party at 708. The results, including any photographs, are transmitted to the parking management server 102 at 710.

In some examples, the photographs of the parked vehicles are transmitted to the parking management server 104 for storage and comparison. Alternatively, other types of images, measurements, etc. are taken and stored by the parking management server 102 for evaluation by the parking management server 102 or the subscriber device 104. As an example, a first image of the parked vehicle in violation of the parking policy is taken, captured, received, and the like at the first identified violation. A second image of the same vehicle parked in violation of the same parking policy is taken at the time of the second identified violation. The first and second images, photographs, measurements, etc. are compared. In some embodiments, the comparison is used to determine whether the violation has been corrected. As an example, a first image is taken of a parked vehicle with a flat tire. Appropriate notice is given to an owner of the parked vehicle with the flat tire, with a time period for correction. After the time period for correction has elapsed, the parked vehicle is recorded in a second image, still with the flat tire. The violation (the flat tire) is not corrected. The subscriber device 104 is notified of the violation, or the subscriber device 104 determines that there is a violation. The violation is presented to the user 132.

As a second example, of the use of two images, a first image is taken of a vehicle parked in a two-hour parking space at the first time. After two or more hours has elapsed, a second image is taken of the same parked vehicle in the same two-hour parking space. The images are compared, to determine whether the parked vehicle has moved. If the parked vehicle did not move, it is determined by the comparison that the parked vehicle is in violation of the two-hour time limit, the subscriber device 104 is notified of the violation, or the subscriber device 104 determines that there is a violation. The violation is presented to the user 132.

In other embodiments, the registration agent 118, in addition to receiving information regarding authorized vehicles, also receives permissible parking times related to the authorized vehicles or designated spaces. As an example, the registration agent 118 receives an indication that a parked vehicle is authorized only for a particular period of time. Alternatively, the registration agent 118 receives an indication that one or more parking spaces are only authorized to be usable during certain hours or for a certain period of time. In this example, if a query is made on a parked vehicle in the one or more parking spaces, the parking management server 102 notifies the subscriber device 104 that there is a temporary authorization, for a specified period of time, or during specific hours (e.g., two hour parking on the weekend, or no parking on Wednesdays, etc.).

FIG. 8 is an example workflow 800, as performed by the subscriber device of the permitless parking system 100. In the example of FIG. 8, the subscriber device 104 downloads the current list of authorized vehicles for the parking area from the parking database 112. The workflow of FIG. 8 illustrates variations which some embodiments of the system include. As an example, in FIG. 8 a “tow ticket” is initiated by the system. Tow tickets are required by law to be issued upon towing a parked vehicle in some municipalities, cities, countries, states, etc. Similarly, in FIG. 8 the system prompts the user 132 regarding special handling instructions relating to the property, or a parked vehicle. Because the system is designed to operate in a plurality of locations, which are regulated by different laws and policies, the experience of an individual user 132 operating an individual subscriber device 104 is different.

FIG. 9 is a block diagram of an example host computing device 900. The subscriber device 104, client device 134, and parking management's server 102 are all host computing devices. Host computing device 900 includes a processor 116 for executing instructions. In some examples, executable instructions are stored in a memory 114. Memory 114 is any device allowing information, such as executable instructions and/or other data, to be stored and retrieved. For example, memory 114 may include one or more random access memory (RAM) modules, flash memory modules, hard disks, solid state disks, and/or optical disks.

Host computing device 900 may include a user interface device 106 for receiving data from a user 132 and/or for presenting data to user 132. User 132 may interact indirectly with host computing device 900 via another computing device such as a device running VMware's vCenter Server or other management device. User interface device 106 may include, for example, a keyboard, a pointing device, a mouse, a stylus, a touch sensitive panel (e.g., a touch pad or a touch screen), a gyroscope, an accelerometer, a position detector, and/or an audio input device. In some examples, user interface device 106 operates to receive data from user 132, while another device (e.g., a presentation device) operates to present data to user 132. In other examples, user interface device 106 has a single component, such as a touch screen, that functions to both output data to user 132 and receive data from user 132. In such examples, user interface device 106 operates as a presentation device for presenting information to user 132. In such examples, user interface device 106 represents any component capable of conveying information to user 132. For example, user interface device 106 may include, without limitation, a display device (e.g., a liquid crystal display (LCD), organic light emitting diode (OLED) display, or “electronic ink” display) and/or an audio output device (e.g., a speaker or headphones). In some examples, user interface device 106 includes an output adapter, such as a video adapter and/or an audio adapter. An output adapter is operatively coupled to processor 116 and configured to be operatively coupled to an output device, such as a display device or an audio output device.

Host computing device 900 also includes a network communication interface 110, which enables host computing device 900 to communicate with a remote device (e.g., another computing device) via a communication medium, such as a wired or wireless packet network. For example, host computing device 900 may transmit and/or receive data via network communication interface 110. User interface device 106 and/or network communication interface 110 may be referred to collectively as an input interface and may be configured to receive information from user 132.

Host computing device 900 further includes a storage interface 916 that enables host computing device 900 to communicate with one or more data storage devices, which store virtual disk images, software applications, and/or any other data suitable for use with the methods described herein. In example examples, storage interface 916 couples host computing device 900 to a storage area network (SAN) (e.g., a Fibre Channel network) and/or to a network-attached storage (NAS) system (e.g., via a packet network). The storage interface 916 may be integrated with network communication interface 110.

### Additional Examples

The following scenarios are merely exemplary and not intended to be limiting in any way.

The disclosed permitless parking system 100 is utilized by property management companies for apartment complexes, businesses, private parking lots, etc. The system operates with cameras based off of tow trucks, in some examples, or camera systems installed at parking areas, or installed on spotter vehicles, on security vehicles, guard shacks, parking gates, lift gates, entrance gates, or other entrances to a parking area. The system engages in authorized vehicle recognition, allowing for the initiation of a tow, boot, or ticket for unauthorized vehicles.

The flexible nature of the client device 134 allows clients 136 such as property managers to effectively add/remove/edit license plate numbers information for owners, add/remove/edit special handling instructions for the parking area, and approve changes in towing service providers.

Similarly, the system permits towing companies quickly update databases to add/edit/remove customers, establish boundaries for a parking area, and add/edit/remove users 132. Tow tickets, vehicle receipts, evidence for insurance claims, and lawsuits are all located on the parking management server 102, and digests, reports, and copies are easily accessible by users 132 or clients 136. Reports include reports on parking areas maintained by user 132, by client 136, reports on activity, etc.

In some embodiments, users 132 confirm or select parking areas, establish geo-fencing, and review and acknowledge special handling instructions. Likewise, alerts for unauthorized vehicles or vehicles parked in violation of restrictions are presented to users 132. Based upon the input of a user 132, the system records the initiation of a tow, boot, or ticket of a vehicle, aggregates information on date, time, location, and photographs of the vehicle.

While directed to the area of non-consent towing, the disclosed method is equally applicable to other vehicle towing, enforcement, tracking, and management areas. As an example, the disclosed system is operable by law enforcement, municipalities, vehicle clubs such as the AMERICAN AUTOMOBILE ASSOCIATION (AAA).

### Exemplary Operating Environment

The operations described herein may be performed by a computer or computing device. The computing devices communicate with each other through an exchange of messages and/or stored data. Communication may occur using any protocol or mechanism over any wired or wireless connection. A computing device may transmit a message as a broadcast message (e.g., to an entire network and/or data bus), a multicast message (e.g., addressed to a plurality of other computing devices), and/or as a plurality of unicast messages, each of which is addressed to an individual computing device. Further, in some embodiments, messages are transmitted using a network protocol that does not guarantee delivery, such as User Datagram Protocol (UDP). Accordingly, when transmitting a message, a computing device may transmit multiple copies of the message, enabling the computing device to reduce the risk of non-delivery.

By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible, non-transitory, and are mutually exclusive to communication media. In some embodiments, computer storage media are implemented in hardware. Exemplary computer storage media include hard disks, flash memory drives, digital versatile discs (DVDs), compact discs (CDs), floppy disks, tape cassettes, and other solid-state memory. In contrast, communication media typically embody computer readable instructions, data structures, program modules, or other data in a modulated data signal such as a carrier wave or other transport mechanism, and include any information delivery media.

Although described in connection with an exemplary computing system environment, embodiments of the disclosure are operative with numerous other general purpose or special purpose computing system environments or configurations. Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other embodiments of the disclosure may include different computer-executable instructions or components having more or less functionality than illustrated and described herein.

Aspects of the disclosure transform a general-purpose computer into a special-purpose computing device when programmed to execute the instructions described herein.

The embodiments illustrated and described herein as well as embodiments not specifically described herein but within the scope of aspects of the invention constitute exemplary means for permitless parking system 100. The registration agent 118 is exemplary means for receiving authorized vehicle information and populating the authorized vehicle module 124. Likewise, the authentication agent 120 is exemplary means for receiving information on parked vehicles, and comparing the parked vehicles to the authorized vehicle module 124. The client device 134 is exemplary means for inputting authorized vehicle information into the parking management server 102. Similarly, the subscriber device 104 represents exemplary means for inputting information regarding parked vehicles into the parking management server 102.

At least a portion of the functionality of the various elements illustrated in the figures may be performed by other elements in the figures, or an entity (e.g., processor, web service, server, application program, computing device, etc.) not shown in the figures.

In some embodiments, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of”.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

We claim:

1. A method for permitless parking management, said method comprising:
receiving, by a computing device, identifying information of one or more vehicles parked in a parking area;
comparing the identifying information of the one or more parked vehicles to information in a database, the information in the database including an indication as to which vehicles are authorized to park in the parking area;
based upon the indication, identifying one of the one or more parked vehicles as unauthorized; and
providing information that the identified parked vehicle is unauthorized to park in the parking area.

2. The method of claim 1, wherein receiving identifying information of one or more parked vehicles further comprises receiving a license plate numbers or a vehicle identification number.

3. The method of claim 2, wherein the license plate number or the vehicle identification number is received as an image, and wherein the method further comprises extracting the identifying information from the image.

4. The method of claim 1, wherein providing information that the identified parked vehicle as unauthorized further comprises providing one or more of the following instructions to: tow the identified parked vehicle, boot the identified parked vehicle, and ticket the identified parked vehicle.

5. The method of claim 1, wherein receiving identifying information of the one or more parked vehicles in the parking area comprises receiving a global positioning system (GPS) location associated with the one or more parked vehicles parked in the parking area.

6. The method of claim 5, wherein the database further comprises parking restrictions, and wherein the method further comprises:
based upon the GPS location, identifying the parking area the one or more parked vehicles are located in;
accessing the parking restrictions for the parking area; and
using the parking restrictions, determining which vehicles of the one or more parked vehicles are authorized to park in the parking area.

7. The method of claim 6, wherein the database further comprises a plurality of geo-fenced locations associated with the parking area.

8. The method of claim 7, wherein at least one of the geo-fenced locations is associated with a vehicle that is authorized to park therein.

9. A system for permitless parking management, said system comprising:
a parking management server;
a database;
a client device comprising a first user interface device and a first vehicle input component; and
a subscriber device comprising a second user interface device and a second vehicle input component; and
wherein the parking management server configured to:
receive, from the client device, a first set of information that identifies at least one vehicle authorized to park in a parking area;
store the first set of information in the database;
receive, from the subscriber device, a second set of information associated with a parked vehicle in the parking area;
compare the second set of information with the first set of information stored in the database;
based on the comparing, determine that the parked vehicle is not the at least one vehicle authorized to park in the parking area; and
upon determining that the parked vehicle is not the at least one vehicle authorized to park in the parking area, notify the subscriber device that the parked vehicle is not authorized to park in the parking area.

10. The system of claim 9, wherein each of the first vehicle input component and the second vehicle input component is a camera or a scanner.

11. The system of claim 9, further comprising an additional database comprising additional violations information, wherein the parking management servers is further configured to:
retrieve the additional violations information, associated with the second set of information, from the additional database;
compare the retrieved additional violations information to the second set of information;
generate a result based upon the comparison; and
communicate the result to the subscriber device.

12. The system of claim 11, wherein communicating the result further comprises notifying one or more of the following of the result: a law enforcement agency, an administrative agency, and a collections agency.

13. The system of claim 11, wherein the retrieved additional violations information comprises one or more of the following: a be on lookout notice, a warrant, a parking violation, a law enforcement alert, and a repossession notice.

14. The system of claim 9, wherein the parking management server is further configured to store a parking policy for the parking area and an authorized vehicle list associated with the parking area.

15. The system of claim 14, wherein the parking management server is further configured to:
receive a location of the parked vehicle from the subscriber device;
compare the location of the parked vehicles with a location of the parking area, the location of the parking area comprising a perimeter that defines the parking area;
determine that the location of the parked vehicle is within the perimeter of the parking area; and
upon determining that the location of the parked vehicle is within the perimeter of the parking area, transmitting the parking policy associated with the parking area and the authorized vehicle list associated with the parking area to the subscriber device.

16. The system of claim 9, wherein the parking management server is further configured to:
receive, from the client device, a request to de-authorize an authorized vehicle; and
based on the received request, remove the de-authorized vehicle from a list of authorized vehicles in the database.

17. A computer-storage memory embodied with instructions to enable remote authentication of a parked vehicle, the instructions causing a processor to:
access, from a parking database, vehicle registration information that identifies one or more vehicles as authorized to park in a parking area;
receiving, from an authentication agent, a query on a parked vehicle in the parking area;
in response to the query, determining whether the parked vehicle is one of the one or more registered vehicles; and
upon determining that the parked vehicle is not one of the one or more registered vehicles, notifying a subscriber device that the parked vehicle is not authorized to park in the parking area.

18. The computer-storage memory of claim 17, wherein the instructions further cause the processor to:
receive a first image of the parked vehicle, the first image comprising a time stamp that identifies a time the first image was captured;
receive a second image of the parked vehicle, the second image comprising a time stamp that identifies a time the second image was captured;
compare the first image and the second image; and
based upon the comparison, alert the subscriber device that the parked vehicle has not moved between the time the first image was captured and the time the second image was captured.

19. The computer-storage memory of claim 17, wherein the instructions further cause the processor to:
receive, from a registration agent, an indication that the parked vehicle is authorized to park in the parking area for a defined period of time;
determine that the defined period of time has elapsed; and
upon determining that the defined period of time has elapsed, notifying the subscriber device that the parked vehicle is not authorized to park in the parking area.

20. The computer-storage memory of claim 17, wherein the instructions further cause the processor to:
receiving a first image of the parked vehicle;
receiving a second image of the parked vehicle;
comparing the first image and the second image of the parked vehicle; and
based upon the comparison, alerting the subscriber device that the parked vehicle has not corrected an outstanding violation of a parking policy or an outstanding violation of a parking regulation.
